(19) United States
(12) Patent Application Publication
(10) Pub. No.: US 2006/0090202 A1
(43) Pub. Date: Apr. 27, 2006

(54) Methods and systems for data authorization and mobile devices using the same

(75) Inventors: Jiann-Tsuen Liu, Dounan Township (TW); Tse-Ming Tsai, Sanchung (TW); Shu-Ling Hsiao, Zhonghe City (TW); Ren-Dar Yang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Institute for Information Industry

(21) Appl. No.: 11/024,350

(22) Filed: Dec. 28, 2004

(30) Foreign Application Priority Data
Oct. 27, 2004 (TW) 93132527

(51) Int. Cl. G06F 12/14

(52) U.S. Cl. 726/17

(57) ABSTRACT

Methods for data authorization. A shared packet comprising data and corresponding data rules is received. A rule process is implemented according to the data rules and default data rules. An authority inference process is implemented on the data according to the rule processing result and context information. An access control list is generated and authorized operations corresponding to authorization definitions of the access control list are executed.

### BACKGROUND

The invention relates to methods for data processing, especially to methods for data authorization between mobile devices.

Mobile communication devices have been widely used so that data exchange between mobile communication devices is required. Most mobile communication devices can share mobile data using wireless communication protocols and, for example, emails can be sent through General Packet Radio Service (GPRS) protocol and data shared through Wireless Fidelity (WiFi) technologies (i.e. IEEE 802.1b). Additionally, two mobile devices can also achieve data sharing utilizing synchronization or asynchronization mechanisms or wired or wireless communication media. The described sharing methods, however, are incapable of controlling and managing data authorities.

Generally, mobile data stores in mobile devices belong to distributed data, shared using peer-to-peer (P2P) communication technologies and managed based on static rules and role recognition. Role-based systems are moderately adjustable without flexibility and are powerless when environmental factors significantly change, for example, different applied roles, situations, and data objects. Currently, data authority control, management, and sharing methods comprise role-based delegation, information rights management (IRM), and enterprise privacy authorization language (EPAL).

Role-based delegation achieves data sharing requirements by the way of role delegation and implements authorized operations by role setting. A grantor, however, can ineffectively control and regulate authorized data due to the lack of constant authority monitoring in runtime. Thus, data with higher security and privacy levels cannot be effectively controlled and managed throughout the whole course, such that security concerns still exist.

With Office 2003, Microsoft has introduced integrated digital rights management (DRM) software, which it calls Information Rights Management (IRM). This feature allows the creator of a document to control what a user can do with it, such as printing, forwarding, or even reading it. Furthermore, these permissions can be changed by Office 2003 on the reader's computer checking over the network with the owner's Windows server to see if the requested use is permitted. The IRM is applied to information security, empowering data owners with greater authority control and management capability. Further, the IRM encodes and decodes data and rules using Rights Management Services (RMS) and grants the data based on data owners. The IRM, however, is merely applied to the Microsoft's platform and must cooperate with domain control and management or NET passport services. Additionally, the IRM has no elasticity in authority control, is not provided with a context-aware concept, and lacks constant authority monitoring capability in runtime.

The EPAL developed by the IBM cooperation is a fine-grained enterprise privacy language, abstracting deployed data comprising data models, user authorization, and the like, centrally authorized. Thus, drawbacks of the EPAL, are centralized authorization, static authority descriptions, and the lack of a context-aware concept.

Furthermore, with the increase in requirements for data sharing and interaction and the growth of mobile communication technologies, data sharing can occur randomly and accidentally. To achieve complex data sharing requirements, scalable and secure data authorization method is desirable.

### SUMMARY

Methods for data authorization are provided. In an embodiment of such a method, a shared packet comprising data and corresponding data rules is received. A rule process is implemented according to the data rules and default data rules. An authority inference process is implemented on the data according to the rule processing result and context information. An access control list is generated and authorized operations corresponding to authorization definitions of the access control list are executed.

Also disclosed are mobile devices provided with default data rules. An embodiment of such a mobile device comprises a data processing module, a rule processing module, a context monitor module, and an authority processing module. The data processing module translates a received shared packet to data and corresponding data rules. The rule processing module implements a rule process according on the data rules and the default data rules. The context monitor module monitors context information. The authority processing module implements an authority inference process on the data according to the rule processing result and context information, generates an access control list, and executes authorized operations corresponding to authorization definitions of the access control list.

Further disclosed are systems for data authorization. An embodiment of such a system comprises a first mobile device and a second mobile device. The first mobile device is provided with data and corresponding data rules, packaged as a shared packet using a session key. The second mobile device is provided with global data rules, when detecting the first mobile device, receiving the shared packet from the first mobile device using a peer-to-peer wireless communication protocol, translating the shared packet to the data and corresponding data rules, implementing a rule process according to the data rules and global data rules, implementing an authority inference process on the data according to the rule processing result and context information, generating an access control list, and executing authorized operations corresponding to authorization definitions of the access control list.

### BRIEF DESCRIPTION OF THE DRAWINGS

Systems and methods for data authorization can be more fully understood by reading the subsequent detailed description and examples of embodiments thereof with reference made to the accompanying drawings, wherein:

FIG. 1 is a schematic diagram of an embodiment of a system for data authorization;

FIG. 2 is a schematic diagram of an embodiment of interaction between context information and data rules;

FIG. 3 is a flowchart of an embodiment of a method for data authorization;

FIG. 4 shows workflow of an embodiment of a method for data authorization; and

FIG. 5 is a schematic diagram of an embodiment of authority rule processing.

### DETAILED DESCRIPTION

Embodiments of the invention disclose methods and systems for data authorization and mobile devices using the same.

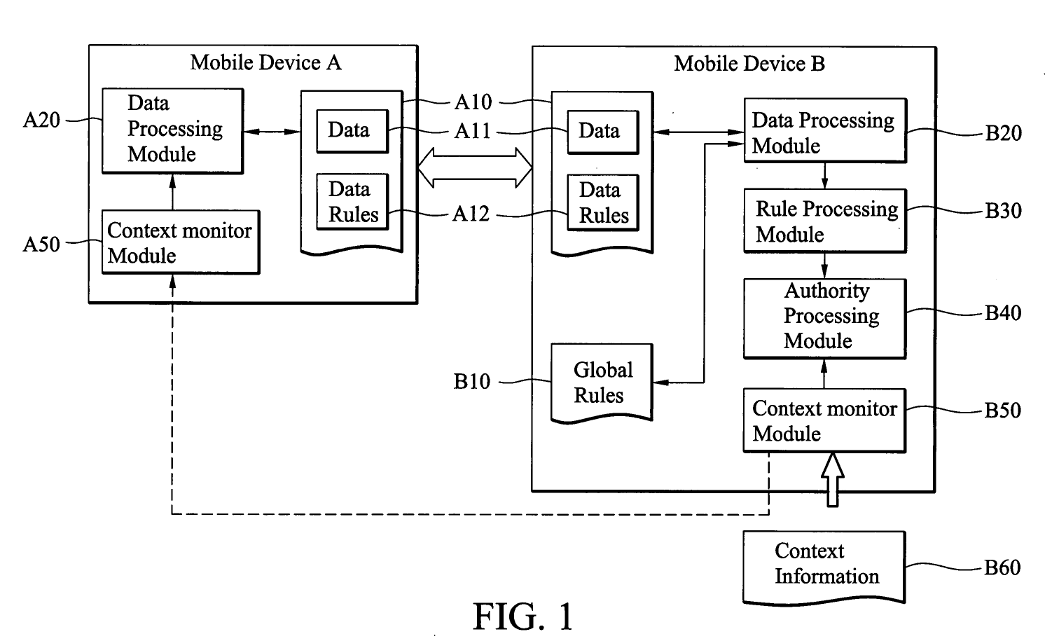

Several exemplary embodiments of the invention will now be described with reference to FIGS. 1 through 5, which generally relate to data sharing between mobile devices. In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic diagram of an embodiment of a system for data authorization, comprising a mobile device A and a mobile device B. Embodiments of the invention use two mobile devices (applied by different mobile users) as examples but are not intended to limit the invention to the precise embodiments disclosed herein.

The mobile device A comprises at least one data processing module A20 and context monitor module A50 and is provided with data A11 and corresponding data rule A12, packaged as a shared packet A10. The mobile device B comprises a data processing module B20, a rule processing module B30, an authority processing module B40, and a context monitor module B50. Additionally, in addition to a shared packet (not shown) similar to shared packet A10, the mobile device B further comprises global rules B10, defined to apply to events and data included therein used for comparison when receiving shared packets from the mobile device A. If data belonging to the mobile device B, for example, is defined as “exclusive” in global rules B10, received data defined as “sharable” from other mobile devices will also be defined as “exclusive”. In the embodiments of the invention, the mobile device A comprises the same function modules and global rules as the mobile device B does, but FIG. 1 only illustrates data processing module A20 and context monitor module A50 for simplification. The details of an embodiment of the data authorization process are described in the following.

Data stored in the mobile device A is first created or retrieved from a data storage device or system and data rules corresponding to the data are then defined. In this embodiment of the invention, the mobile device A is defined as a data owner and the mobile device B is defined as a data requester, indicating that the mobile device B can request mobile data from the mobile device A, so that FIG. 1 only illustrates detailed components of the mobile devices B. In practice, each mobile device is designed as the same structure and can act as a data owner or data requester.

Data A11 of the mobile device A can be tables, fields, documents, extensible markup languages, and other data objects in practice. For peer-to-peer data transfer requirements, data is defined as a minimum exchanged file object but is not intended to limit the invention in practice. Data rules A12 corresponding to data A11 comply with dynamic real-time access control standards that can be distributed data rules, and, in practice, can be set up using rule description languages, such as open digital rights language (ODRL), extensible rights markup language (XrML), and others, but is not limited to the embodiments disclosed herein.

Next, some embodiments of data rules are conceptually described herein, defined using terms defined above in practice.

Data rule 1 indicates that a mobile user B (the owner of the mobile device B) is at a workplace at working hours and refers to data C stored in the mobile device A via the mobile device B when a mobile user A (the owner of the mobile device A) is present.

Data rule 2 indicates that the mobile user B can make use of data E stored in the mobile device A when authorization data D is included in the mobile device B.

Data rule 3 indicates that the data C can be used for only one day.

Data rule 4 indicates that the data E can be synchronized.

The above data rules can be applied to mobile device A or B respectively.

Next, the mobile devices A and B mutually detect each other through context monitor modules A50 and B50, respectively, using a context-aware mechanism. The mobile devices A and B check stored data thereof respectively and the mobile device A determines whether data A11 can be shared with the mobile device B. If the mobile device A has data for which the mobile device B lacks and the data is defined as “sharable” (e.g. the data owner define that the data would be sharable as the data owner present at the workplace), data processing module A20 of the mobile device A executes sharing operations to share the data with the mobile device B. If the mobile device A has no data wanted by the mobile device B or the data is defined as “exclusive”, data processing modules A20 and B20 of the two mobile devices A and B will do nothing, and the mobile device B then continually detects other mobile devices using context monitor modules A50.

When the mobile device A executes a data sharing operation, data processing module A20 negotiates with data processing module B20 to generate a session key, used for packaging data A11 and corresponding data rules A12 as a shared packet A10, and the shared packet A10 is then transferred to the mobile device B using a peer-to-peer communication protocol. Shared packet A10, received by data processing module B20 is translated to data A11 and corresponding data rules A12 using the session key.

Next, rule processing module B30 implements a rule process on data A11 and corresponding data rules A12. Data rules A12 retrieved from the mobile device A may conflict with global rules B10 of the mobile device B, consequently, rule combination or a conflict process must be enforced. After the rule process is complete, authority processing module B40 implements an authority inference process on data A11 according to the rule processing result and context information B60 obtained by context monitor module B50.

“Context information” can be acquired using a context monitor module of a mobile device. Additionally, the mobile device executes the context monitor operation continuously and repeatedly at time intervals for updating the information. In the following, context information for locations is described. A detector, for example, a workplace detector A, is located at a workplace A, and a context monitor module of a mobile device can detect the workplace detector A at the workplace A. In this embodiment of the invention, context information comprising a role, event, time, location, group, or device, is acquired by such a method, but is not intended to limit the invention in practice.

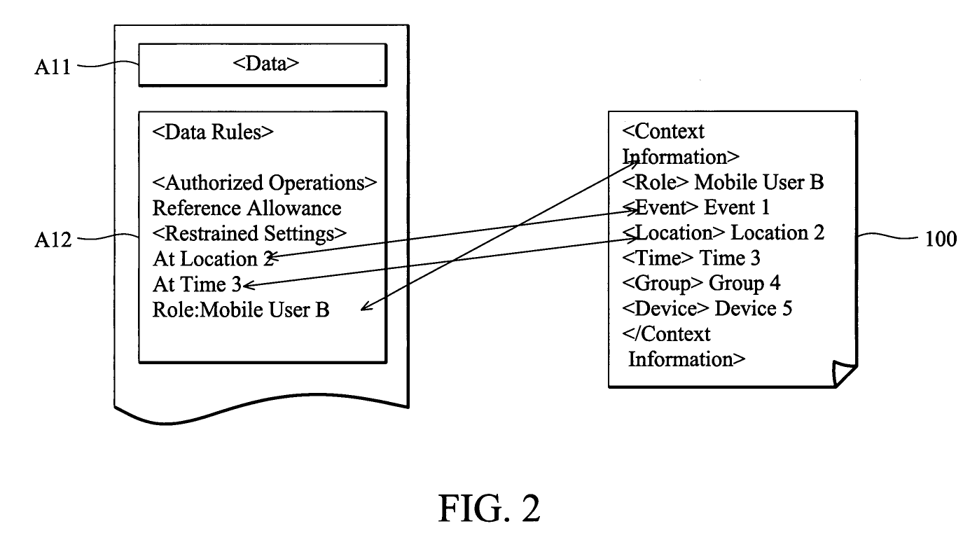

Referring to FIG. 2, a schematic diagram of an embodiment of interaction between context information and data rules, data rules A12 are set as follows, “authorized operations” comprise “reference allowance”, and “restrained settings” comprise “at location 2”, “at time 3”, and “role: mobile user B”, that is to say, the mobile user B can refer to data A11 of the mobile device A at “location 2” at “time 3” but other operations such as copy or deletion are prohibited.

After the authority inference process is complete, authority processing module B40 generates an access control list comprising authorized operations corresponding to all data stored in the mobile device A, and reads or modifies the retrieved data from the mobile device A in accordance with the access control list.

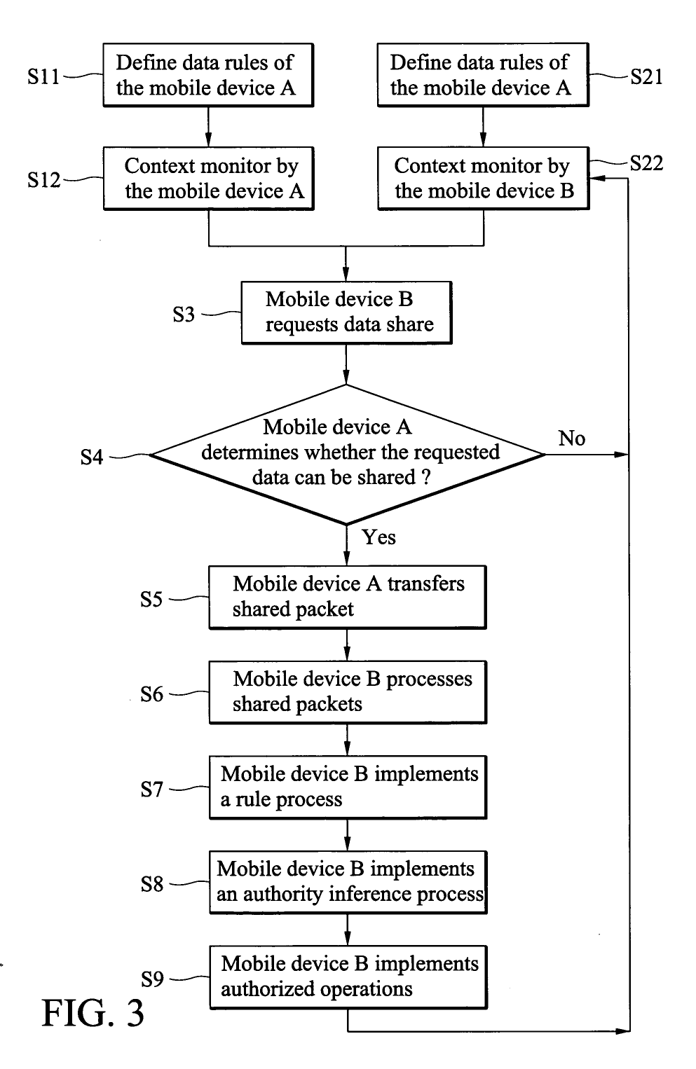

FIG. 3 is a flowchart of an embodiment of a method for data authorization, dynamically controlling and managing the access right of mobile data for privacy and security protection.

The data authorization process begins by creating or retrieving data from a storage device or system by a mobile device A and defining data rules corresponding to the data (step S11) and global rules corresponding to existed data stored in a mobile device B (step S21). Next, the mobile devices A and B mutually detect each other through context monitor modules thereof, respectively, using a context-aware mechanism (steps S12 and S22). The mobile device B requests data sharing with the mobile device A (step S3) and the mobile device A determines whether the requested data can be shared (step S4). If so, the process proceeds to step S5, and, if not, to step S22 for another detecting operation by the mobile device B.

Next, when mobile device A executes a data sharing operation, both mobile devices A and B negotiate a session key, and mobile device A packages the data and corresponding data rules as a shared packet, transferred to the mobile device B using a peer-to-peer communication protocol (step S5). When the shared packet is received, mobile device B translates it to the data and corresponding data rules using the session key (step S6). Next, the mobile device B implements a rule process on the data and corresponding data rules (step S7). The data rules retrieved from the mobile device A may conflict with the global rules of the mobile device B, such that, rule combination or a conflict process must be enforced. After the rule process is complete, the mobile device B implements an authority inference process according to the rule processing result and obtained context information (step S8). After the authority inference process is complete, the mobile device B generates an access control list comprising authorized operations corresponding to all data stored in the mobile device A, and reads or modifies the retrieved data from the mobile device A in accordance with the access control list (step S9).

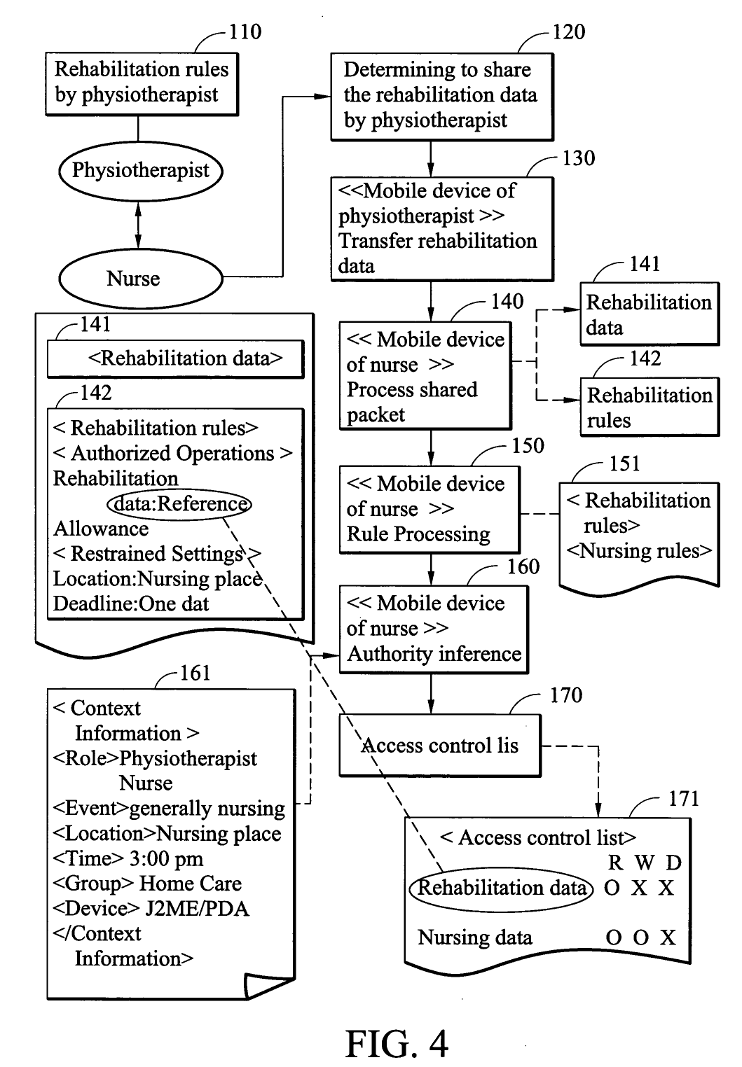

According to an embodiment of data authorization of the invention, referring to FIG. 4, a mobile device belonging to a physiotherapist comprises related rehabilitation data of nursing cases. The physiotherapist defines rehabilitation rules corresponding to the rehabilitation data in accordance with privacy of nursing cases and working requirements (110). Next, when the mobile device of the physiotherapist and a nurse are in the same nursing place, the mobile device of the physiotherapist detects that of the care worker, determining to share the rehabilitation data (120) and transferring an encoded shared packet to the mobile device of the nurse (130). When the shared packet is received, the mobile device of the nurse translates it to rehabilitation data 141 and corresponding rehabilitation rules 142 (140), and implements a rule process in accordance with data rules 151 comprising rehabilitation rules and nursing rules (150). Next, the mobile device of the nurse implements an authority inference process on the rehabilitation data according to the rule processing result and current context information 161. Context information 161 shows “Role: physiotherapist and nurse”, “Event: generally nursing”, “Location: nursing place”, “Time: 3:00 pm”, “Group: Home Care”, and “Device: J2ME/PDA”.

According to the inference result, the mobile device thereof updating an access control list 171 thereof. Thus, the nurse can refer to the rehabilitation data in the mobile device thereof.

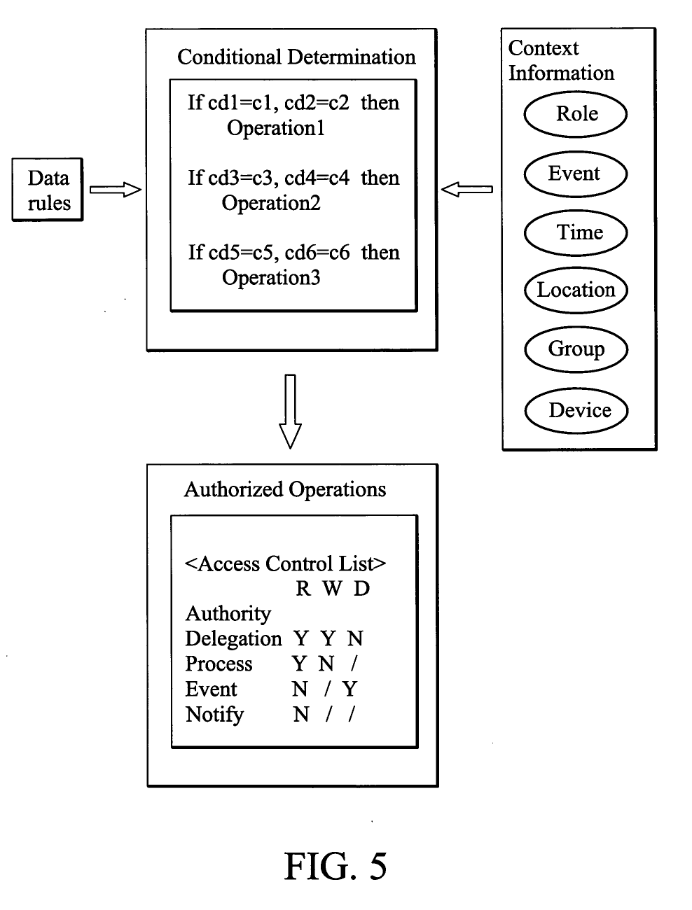

Referring to FIG. 5, when a mobile user shares or exchanges data thereof, a mobile device belonged to the mobile user comprises large amounts of data and corresponding data rules. The mobile device implements corresponding authority inference processes according to the data rules and newly monitored context information. As shown in FIG. 5, for example, if conditions 1 and 2 are satisfied, the operation 1 is implemented, and if conditions 3 and 4 are satisfied, the operation 2 will be implemented. The condition 1 is a data rule or context information, as well as the conditions 2˜4. when conditions are satisfied, the corresponding authorized operations are implemented and a corresponding access control list is subsequently revised. The symbols “Y” and “N” of the access control list shown in FIG. 5 indicate that authorized operations corresponding to the data are allowable or restrained, and the symbol “/” indicates authorized operations corresponding to the data are not yet triggered. The priority of data increases with all authorized operations of the data inferred more completely. With constantly updated context information, more triggered authorized operations are produced, and the access control list is updated continuously.

Embodiments of the invention are capable of automatic context-aware function for data sharing requirements, implemented according to monitored context information and customized data rules. Further, mobile devices can synchronize data between each other and assign different authorities to data in accordance with set data rules.

Although the present invention has been described in preferred embodiments, it is not intended to limit the invention thereto. Those who are skilled in this technology can still make various alterations and modifications without departing from the scope and spirit of this invention. Therefore, the scope of the present invention shall be defined and protected by the following claims and their equivalents.

What is claimed is:

1. A method for data authorization, comprising:
receiving a shared packet comprising data and corresponding data rules;
implementing a rule process according to the data rules and default data rules;
implementing an authority inference process on the data according to the rule processing result and context information; and
generating an access control list and executing authorized operations corresponding to authorization definitions of the access control list.

2. The method as claimed in claim 1, wherein the data and corresponding data rules are packaged as the shared packet using a session key.

3. The method as claimed in claim 2, wherein shared packet receipt further comprises translating the shared packet to the data and corresponding data rules using the session key.

4. The method as claimed in claim 1, wherein the data rules are user-defined and the data is assigned different access authorities.

5. The method as claimed in claim 1, wherein data rule implementation further comprises determining conflict or redundancy between the data and default rules and implementing rule combination or a conflict process according to the result.

6. The method as claimed in claim 1, wherein the context information is updated at time intervals.

7. The system as claimed in claim 1, wherein the shared packet is received using a peer-to-peer wireless communication protocol.

8. A mobile device provided with default data rules, comprising:
a data processing module, translating a received shared packet to data and corresponding data rules;
a rule processing module, implementing a rule process according to the data rules and the default data rules;
a context monitor module, obtaining context information; and
an authority processing module, implementing an authority inference process on the data according to the rule processing result and context information, generating an access control list, and executing authorized operations corresponding to authorization definitions of the access control list.

9. The mobile device as claimed in claim 8, wherein the data and corresponding data rules are packaged as the shared packet using a session key.

10. The mobile device as claimed in claim 9, wherein the data processing module translates the shared packet to the data and corresponding data rules using the session key.

11. The mobile device as claimed in claim 1, wherein the data rules are user-defined and the data is assigned different access authorities.

12. The mobile device as claimed in claim 1, wherein the data processing module determines conflict or redundancy between the data and default rules and implements rule combination or a conflict process according to the result.

13. The mobile device as claimed in claim 1, wherein the context monitor module updates the context information at time intervals.

14. The mobile device as claimed in claim 1, wherein the data processing module receives the shared packet using a peer-to-peer wireless communication protocol.

15. A system for data authorization, comprising:
a first mobile device provided with data and corresponding data rules, packaged as a shared packet using a session key; and
a second mobile device provided with global data rules, which, when detecting the first mobile device, receives the shared packet from the first mobile device using a peer-to-peer wireless communication protocol, translating the shared packet to the data and corresponding data rules, implementing a rule process according to the data rules and global data rules, implementing an authority inference process on the data according to the rule processing result and context information, generating an access control list, and executing authorized operations corresponding to authorization definitions of the access control list.

16. The system as claimed in claim 15, wherein the data rules are user-defined and the data is assigned different access authorities.

17. The system as claimed in claim 15, wherein the context monitor module updates the context information at time intervals.
